(19) United States
(12) Patent Application Publication
(10) Pub. No.: US 2009/0310945 A1
(43) Pub. Date: Dec. 17, 2009

(54) Bulk dispensing machine having video animation and audio

(76) Inventor: George W. Stallings, Houston, TX (US)

Correspondence Address: JAMES L. JACKSON;James L. Jackson P.C., 10723 Sugar Hill Dr., Houston, TX, 77042, US

(21) Appl. No.: 12/455,519

(22) Filed: Jun. 3, 2009

Related U.S. Application Data
(60) Provisional application No. 61/131,656, filed on Jun. 11, 2008.

(51) Int. Cl. H04N 7/26

(52) U.S. Cl. 386/124; 386/E05.028

(57) ABSTRACT

A coin controlled article dispensing machine having a computer controlled video monitor mounted thereon is provided having an operational sequence that is controlled by computer program and presents integrated video and audio animation from recorded media to attract the attention of potential customers and stimulate the sale of an article that is dispensed by the machine responsive to deposit of coins. The recorded video and audio is designed to entertain the customer during purchase and dispensing of the article and stimulate additional sales. A programmable logistics controller provides for synchronized presentation of video and audio and selects a standby sequence playing video and audio from a recorded media and a customer purchase mode playing video and audio from another recorded media.

Applicant hereby claims the benefit of U.S. Provisional Application Ser. No. 61/131,656, filed on Jun. 11, 2008 by George W. Stallings and entitled “Coin Actuated Bulk Vending Machine Having Integrated Animated Audio and Video”, which Provisional Application is incorporated herein by reference for all purposes.

### BACKGROUND OF THE INVENTION

1. Field of the Invention

The present invention relates generally to coin controlled machines for dispensing small articles. More particularly, this invention concerns dispensing machines having operational sequences that are initiated by deposit of a coin. Even more specifically the present invention concerns coin controlled article dispensing machines having an operational sequence that is controlled by computer program and integrated video and audio animation is presented to a customer to stimulate the sale of an article and to entertain the customer during purchase and dispensing of the article.

2. Description of the Prior Art

Check or coin controlled article dispensing machines are well known in the art. Early on such article dispensing machines were mechanically or electro-mechanically controlled and actuated. More recently article dispensing machines, often referred to as “gum ball machines”, have incorporated computer control for enhancement and simplification of an article dispensing process. In some cases coil initiated article dispensing machines are provided with LCD displays, plasma panels or CRT displays to provide customers with visual presentations to stimulate the purchase of articles from the machine.

### SUMMARY OF THE INVENTION

It is a principal feature of the present invention to provide a novel coin actuated and computer controlled article dispensing machine that, in addition to the dispensing of articles such as gum balls in response to sensing deposit of a proper coin into a coin slot, the machine presents integrated video animation and audio to stimulate the purchasing interest of a potential customer and provides entertainment in association with the article dispensing process.

It is another feature of the present invention to provide a novel coin actuated and computer controlled article dispensing machine that incorporates in memory a plurality of differing video animation and audio presentations that are sequentially selected to stimulate prospective purchasers to make multiple purchases while present at the machine.

Briefly, the various objects and features of the present invention are realized through the provision of an article dispensing machine having integrated video animation and audio that are presented continuously to attract the attention of prospective customers, typically children, and to provide entertainment during article dispensing for customers who deposit one or more coins in a coin slot that is provided at the wall structure of the housing.

System Concept: The coin actuated computer controlled bulk vending machine of this invention combines traditional bulk vending devices with interactive computer generated video and audio media to create a unique multi sensory experience that is pleasing to customers and potential customers.

At rest the vending machine of this invention plays a video/audio loop of a computer generated animation or a live action scene that attracts the attention of potential customers and draws them to the machine to see and hear a computer generated and integrated video/audio presentation. Upon the customer depositing money into a coin slot, the machine then switches to a second sequence of events. The second sequence may be as simple as a second video that upon completion rewards the customer with a prize or perhaps a game or other activity that requires further interaction from the customer to receive a prize. Prizes include but are not limited to gum, candy, toys, decals, temporary tattoos, etc.

Machine Description: The coin actuated computer controlled bulk vending machine of this invention can be provided in a variety of shapes and sizes including but not limited to the shape of a rocket ship, clown, dinosaur, movie theater, etc. Machine shells are constructed from one or a combination of materials such as fiberglass, acrylic plastic, urethane plastic, steel, aluminum and wood. The housing preferably has a pleasing form, such as the form of a brightly colored rocket or space ship to stimulate the interest of children and defines one or more openings for video and audio presentation. It is only desirable that the shape of the machines be pleasing to potential customers, children.

The vending machines of the present invention have video/audio and control systems that are composed of animated or live action video/audio stored in digital or analog format on one or more of a wide variety of recording media such as Flash cards, compact disks (CD), digital video disks (DVD), video/audio tape or other electronic recording media. Video/audio is played back via either a flash card player, CD payer, DVD player, video/audio tape player, PC or other devices. Video/audio playback, timing sequences, lighting, motors, customer interaction controlled by programmable logistics controller (PLC), PC, CPU, solid state or digital relays or other devices.

Sequence of Events: The coin actuated computer controlled bulk vending machine of this invention typically functions in standby mode when an article dispensing operation is not in progress and in the standby mode substantially continuously plays video/audio loop from a memory media, the audio/video loop being displayed on a monitor or monitors and presented by audio speakers. When a customer deposits money into the machine this activates the programmable logistics controller (PLC) or other controlling device to either: A) Play a second video and activate other media such as lighting, vibrations, sounds, etc. which upon completion, the PLC will activate a hopper motor to deliver a prize from a storage hopper to a prize drop receptacle. Some machines will be equipped with a choice of several audio/video presentations to choose from. B) Start a video game that the user controls via buttons, joystick, etc. mounted to coin actuated computer controlled bulk vending machine or touch screen interaction. The user's level of success will determine the number of prizes they receive. Again the PLC or other device will activate the motor to deliver prize(s). After prizes have been delivered the coin actuated computer controlled bulk vending machine will return to standby mode and wait for the next customer, substantially continuously presenting a video/audio presentation for attraction of customers.

Within the housing is mounted electronic and computer circuitry for operation and control and provides an arrangement of one or more video screens and screen synchronized audio which is integrated with the electronics of the coin operating system and article dispensing equipment. Computer apparatus presents a programmed image from one or more video cards which is presented by a video screen to attract the intention of persons, typically children, who enjoy using the machine and enjoy using the articles, gum balls in this case. Alternatively, the machine can easily dispense a variety of different kinds and sizes of articles, so it is not intended to limit the invention to gumball dispensing.

The electronics and electromechanical components of the machine are contained within front and rear compartments each being accessible via compartment doors each having locks. The front compartment, in addition to coin handling apparatus, also contains a receptacle or repository for the coins, typically quarters that are inserted into the machine via a coin slot of a coin actuated switch.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is a front elevational illustration showing a coin actuated and computer controlled article dispensing machine embodying the principles of the present invention and constituting the preferred embodiment of the invention;

FIG. 2 is a side elevational view of the coin actuated and computer controlled article dispensing machine of FIG. 1, being partially cut away and showing internal features of the machine for computer controlled article dispensing, animated video presentation and integrated audio presentation;

FIG. 3 is a plan view of the coin actuated and computer controlled article dispensing machine of FIGS. 1 and 2;

FIG. 4 is a block diagram component illustration showing electronic control circuitry of the coin actuated and computer controlled article dispensing machine of FIGS. 1-3; and

FIG. 5 is another block diagram schematic component illustration showing electronic control circuitry of the coin actuated and computer controlled article dispensing machine of FIGS. 1-3.

### DETAILED DESCRIPTION OF PREFERRED EMBODIMENT

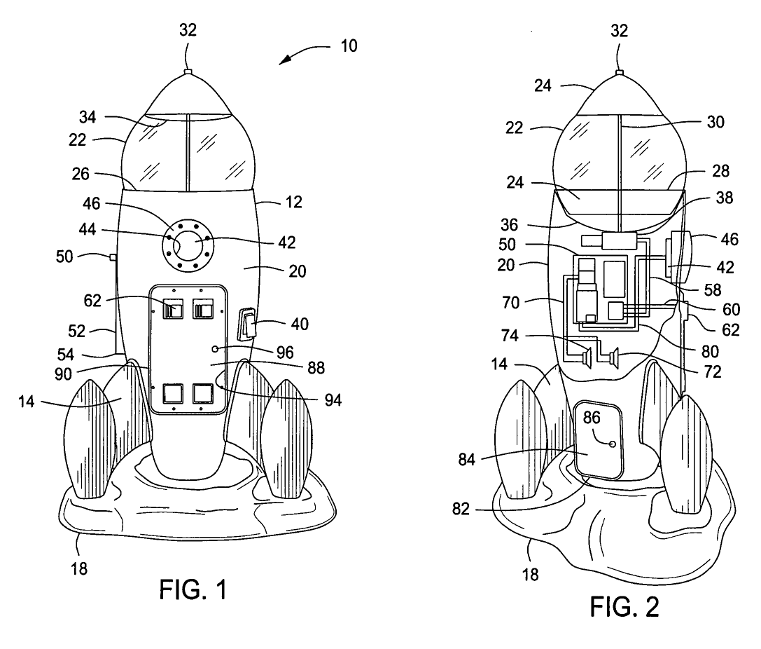

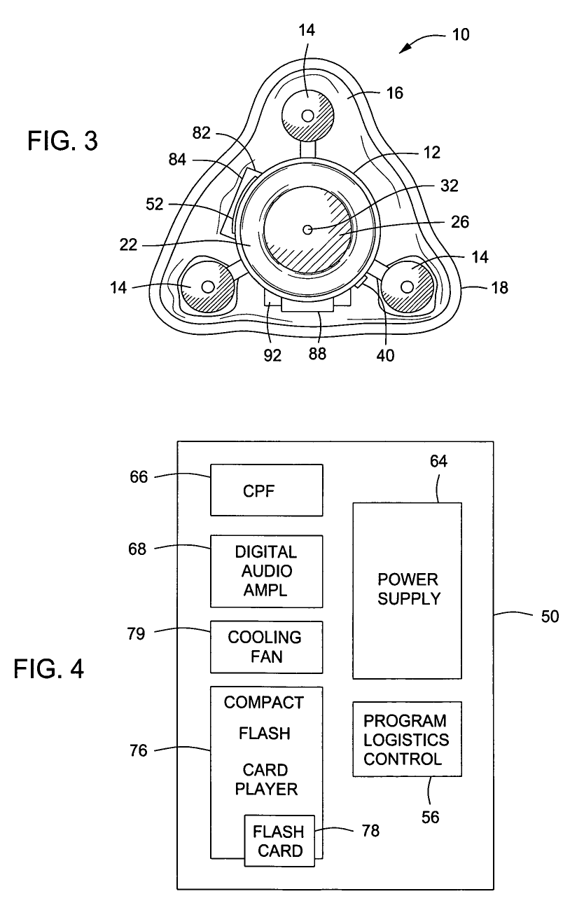

Referring now to the drawings and first to FIG. 1, a coin actuated and computer controlled article dispensing machine embodying the principles of the present invention is shown generally at 10 and defines a dispensing machine housing 12 having support legs 14 that are fixed to a support base 16. The support base is a decorative as well as a functional member and has irregular edges 18 that are designed for location within a common plane so that the machine will rest on a floor surface of a building.

The housing 12 incorporates a downwardly and inwardly tapered body 20 preferably having a substantially circular configuration and is topped by a rounded, substantially clear plastic article viewing member 22 that permits users of the machine to see the articles that are stored in a hopper 24 that is mounted within the upper portion of the tapered housing 20. A generally conical closure member 26 is removably secured to the upper generally circular rim 28 by a retainer member 30 that is mounted generally vertically within the tapered housing 20 and located substantially centrally of the clear plastic closure 22. A retainer nut 32 is threaded or otherwise attached to the upper end of the retainer member 30 and permits the conical closure member 26 to be removed to permit additional articles to be poured through a circular opening 34 of the clear plastic article viewing member 22 of the housing 12.

The lower end portion of the retainer member 30 is fixed centrally of the lower wall portion 36 of the hopper 24. A hopper motor 38 is mounted to the lower wall structure 36 of the hopper 24 and is operative, when actuated, to initiate movement of an article from the hopper to a prize drop receptacle 40 that is mounted externally of the tapered housing 20 and is positioned so that a customer (typically a child) can easily retrieve a dispensed article from the machine.

A computer controlled monitor 42 is located within the tapered housing 20 and is visible to the customer through a monitor viewing opening 44 of the tapered housing 20. A monitor retaining ring 46 surrounds the monitor viewing opening 44 and is secured to an external surface portion of the tapered housing 20 by means of screws, rivets or any other suitable retainer members. Though the monitor retaining ring 46 may be fixed to the housing, such as by means of an adhesive or bonding agent, it is desirable to support the monitor retaining ring 46 on the tapered housing in a manner permitting it to be removed from the housing so that the monitor may be replaced in the event such should become necessary or desirable.

### System Electronics

One or more controller electronics circuit boards 50, shown in greater detail in FIG. 4, is mounted within the tapered housing 20. Preferably, for ease of access to the circuit components, a circuit mounting panel 52 is hinge mounted by a hinge 54 or is otherwise movably mounted to the tapered housing 20. The circuit mounting panel may be oriented in angularly offset relation on the housing 20 with the position of the monitor, prize drop receptacle and coin switch apparatus so that customers will not have ready access to it. The closure will preferably be provided with a panel lock device so that it can be opened only with a key. Pivotal mounting of the circuit mounting panel 52 permits the panel to be unlocked and pivoted downwardly about its lower hinge 54 so that the circuit components are exposed for easy access and service as needed.

The controller electronics circuit board or boards 50 of FIGS. 1 and 4 has mounted thereto a programmable logistics controller (PLC) 56 as shown in greater detail in FIG. 4. When a coin is dropped into the coin slot of the machine, is verified and activates a coin drop switch the PLC 56 receives a signal from the coin drop switch thus sending an electronic signal to the compact flash card player (CPF), causing the CPF to cease play of the first video/audio presentation and initiate play of the second video/audio presentation. It should be borne in mind that the first or initial video/audio presentation can be selected from a plurality of such presentations that are selected automatically and sequentially by the PLC from the recording media of the CPF. During the standby mode the PLC periodically selects from any of a series of recorded video/audio presentations so that potential customers will not tire of the loop video/audio feed that is being presented. The PLC also controls the activation of the lighting system of the machine as well as sending a signal to the hopper motor at the appropriate time so that the machine will drop its prize at the end of the second video/audio presentation. When the article dispensing cycle has been completed the PLC signals the CPF to return to the initial loop video/audio (standby mode).programmable logistics controller (PLC) shown at 56. PLC 56 is the primary control system of the electronics system for the bulk vending machine. The PLC is basically a complex timer that can be downloaded with custom software that provides for operation and control of all aspects of machine operation. The PLC is a very versatile electronic recording device that can be programmed or reprogrammed at any point in time, providing the option for running alternative video/audio presentation scenarios sequentially or serially on the same machine. The PLC instructs the compact flash card player (CPF) to play the initial loop video/audio presentation during the standby mode of the machine, with the initial loop having a plurality of animated presentations to maintain the attention of prospective customers.

A circuit conductor 58 connected with the PLC and with a hopper motor 38 for control of the hopper motor responsive to a purchase by a customer. Another circuit conductor 60 is connected with the PLC and is also electrically connected with one or more coin switch mechanisms 62 as shown in FIG. 1. A coin dropped by a customer into the coin slot of the coin switch is sensed and initiates the circuit conductor 60 and provides an operation initiation signal to the PLC to sequentially initiate the hopper motor via circuit conductor 58. As mentioned above, initiation of the hopper motor 38 causes dispensing activity for delivery of an article from the hopper to the prize drop receptacle 40.

The controller electronics circuit board or boards 50 also provides a power supply 64, which in this case is a 12 volt dc 20 amp power supply for operation of the various circuit components of the article dispensing system. The 12 vdc 10 amp power supply converts 115 vac power to 12 vdc power. All components of computer controlled bulk vending machine of this invention are powered by 12 vdc of the power supply. The power supply allows machine to be connected into any standard 115 vac electrical wall outlet.

Mounted to the circuit board 50 is a compact video flash card player interface (CPF) 66 and a digital audio amplifier 68 which are coupled by an audio conductor cable 70 to a pair of speakers 72 and 74. Digital Audio Amplifier 68 receives a digital audio Signal from the CPF and outputs to speakers. This feature causes the amplified audio recording of the compact flash card player interface 66 to be presented to the customer in conjunction with recorded video signal feed from a compact video flash card player 76 (having a compact flash card 78 connected therewith. The compact flash card player plays video and audio from the memory of the flash card 78 as selected by the PLC. Compact Flash Card or memory card 78 is where all video and audio information is stored. The card is easy to remove and replace, again providing the bulk vending machines of the present invention with the opportunity to run alternative programs. The flash card 78 receives input signals from the PLC via the CPF Interface and sends a digital video signal to the monitor(s) mounted in front of bulk vending machine that displays all video images. The flash card also sends digital audio signals to the amplifier 68 for projection of all audio at the speakers 72 and 74. The compact flash card player interface CPF 66 receives a signal from the PLC and controls selection and operation of one or more recorded, i.e., programmed video/audio presentations of the CPF. A cooling fan 79 is also mounted to the circuit board 50 and is substantially continuously operated to provide the electronics of the control and operation circuitry of the circuit board with sufficient cooling to promote the extensive service life of the electronics.

Another electronic conductor 80 is connected with the compact video flash card player 76 and with the video monitor 42 and functions responsive to signals of the PLC controller 56 to deliver video and audio feed loop signals to the video monitor and audio speakers. The video flash card player 76 may be changed out in the event of flash card memory degradation or it may be replaced with an upgraded video recording in its memory as desired. The audio and video loops of the compact video flash card player interface 66 and the video flash card player interface 76 are integrated so that the animated video presentation of the monitor 42 and the audio presentation cause the animated video image to appear to be speaking to the potential customer. Moreover, these computer generated video and audio loops are operated substantially constantly so as to provide an interesting attractive video/audio presentation to stimulate nearby potential customers or passers by to witness the video and audio presentation and come to a decision to purchase an article that is to be dispensed. And when a coin is introduced into the slot or slots of the coin switch, the animated video and associated audio loops will be electronically actuated to provide a customer with a pleasing and interesting presentation.

Below the circuit mounting panel 52 is provided a coin collection box 82 having an access door 84 having a lock 86. Article purchase coins that have been accepted for purchase will be conducted to the coin collection box 82. By opening the lock 86 the coin collection box access door 84 can be opened by authorized personnel and the coins collected therein can be removed and transported to a collection and accounting facility for safekeeping.

Electronic and electromechanical coin switch apparatus is fixed to a door type closure 88 that is mounted by a hinge 90 to the wall structure of the housing 20. A projection 92 extends from the housing wall and defines an access opening 94, with the closure 88 being a closure for the access opening. The closure 88 is also provided with a lock 96. Preferably the electronic and electromechanical coin switch apparatus is mounted to the back side of the closure 88. This feature permits the closure 88 to be unlocked and pivoted outwardly about its hinge 90, thus exposing the electronic and electromechanical coin switch apparatus for inspection and service as needed.

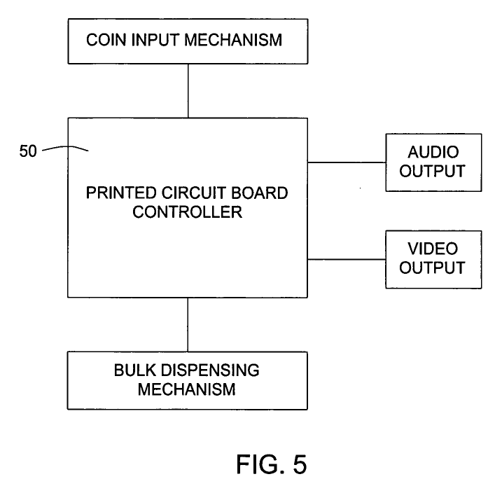

With respect to the block diagram electromechanical circuitry of FIG. 5, an integrated relationship is established between a printed circuit board controller circuit 50 and four mechanical electromechanical and electronic circuit systems to achieve a pleasing animated audio and video display that is pleasing to children, especially small children in the age range of from about one year old to about 5 years of age. The printed circuit board controller unit 50 initiates a vending cycle that is activated by a coin input mechanism^{∞}. However, the audio and video circuits of the machine may also be initialized by a proximity detector so that an animated audio and video sequence is initiated when a person is detected in close proximity to the machine or touches the machine. The audio and video is integrated by the controller circuitry in a manner causing integrated streaming of pre-programmed audio and video sequences, so that an animated figure seen on the video monitor appears to speak to the party using the machine.

The printed circuit controller is separately initiated by deposit of a coin for a vending sequence by a coin input mechanism and also initializes a bulk vending or dispensing mechanism which delivers an object to a pick-up slot or receptacle where the object is presented in position to be retrieved by a user.

According to the method of operation of the coin actuated computer controlled bulk vending machine of this invention a machine is typically located within a business facility that is frequently visited by children or persons of an age that is suitable for purchase of the articles being dispensed. A power cord of the machine is connected into a 115 vac outlet to provide electrical power for the machine. Upon being energized the power supply 64 converts the electrical energy to 12 vdc so that the converted electrical energy is then used to power all of the various electrical and electronic components of the machine.

When energized, the PLC will initiate the presentation of a synchronized video/audio loop sequence, presenting animated video on the video screen 42 and simultaneously presenting synchronized audio from the speakers 72 and 74. This animated presentation is intended to attract the attention of potential customers who may be near the machine at any point in time. The PLC can control the play of a single first video/audio presentation which is repeated as long as the electronic system of the machine is in the standby mode. Alternatively, a plurality of video/audio presentations can be recorded on the flash card 78 and can be selected sequentially by the PLC to attract and maintain the attention of potential customers.

A person having decided to purchase an article from the machine, will drop one or more coins, typically quarters, into the coin slot of a coin actuated switch. Having been activated by the coin or coins, the coin actuated switch will send a purchase signal to the PLC, causing the PLC to provide electronic signals to the CPF interface 66, the audio amplifier 68 and compact flash card player for selection of a second video/audio presentation which may also be referred to as a purchase presentation. The PLC signals will interrupt the video/audio presentation of the standby mode and immediately signal the CPF to shift to a second or purchase mode. The second or purchase presentation will be played for a period of time until it terminates. The PLC will then provide electronic signals to the CPF for returning the video/audio presentation system to the standby mode in readiness for another purchase.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A method for dispensing articles to customers from a bulk vending machine having synchronized video and audio systems, comprising:
substantially continuously presenting a first synchronized animated video/audio presentation from a video screen and audio speakers of a bulk vending machine to attract customer attention;
responsive to sensing deposit of a coin into a coin slot of said bulk vending machine, terminating said first synchronized animated video/audio presentation and presenting a second synchronized animated video/audio presentation for a predetermined period of time; and
upon termination of said predetermined period of time, again substantially continuously presenting said first synchronized animated video/audio presentation.

2. The method of claim 1, comprising:
controlling said first and second synchronized animated video/audio presentations with a programmable logistics controller selecting recorded data from a recording media.

3. The method of claim 1, comprising:
sequentially selecting loop generation of a plurality of recorded video/audio presentations from recorded media during operation of said first synchronized animated video/audio presentation.

4. The method of claim 1, comprising:
with a programmable logistics controller, controlling said first and second synchronized animated video/audio presentations with a programmable logistics controller selecting recorded data from a recording media; and
during said first synchronized animated video/audio presentation, sequentially selecting with said programmable logistics controller, loop play of a plurality of recorded video/audio presentations from recorded media during operation of said first synchronized animated video/audio presentation.

5. A coin actuated, computer controlled bulk article dispensing machine, comprising:
a machine housing having facilities for storing and dispensing articles and a coin drop system providing an article dispensing signal responsive to customer deposit of a coin into said coin drop system;
a video monitor being mounted to said machine housing in position for viewing by potential customers;
an audio system being located within said machine housing; and
a computer controlled system presenting synchronized animated video on said video monitor and audio from said audio system and being responsive to said article dispensing signal.

6. The coin actuated, computer controlled bulk article dispensing machine of claim 5, comprising:
a programmable electronic storage media being electronically connected with said video monitor and audio system; and
a programmable logistics controller being connected to receive said article dispensing signal and being connected for program sequence control of said programmable electronic storage media during a standby mode and during an article dispensing mode.

7. The coin actuated, computer controlled bulk article dispensing machine of claim 5, comprising:
an electronic control and operation system being mounted within said machine housing and having digital video and audio memory media; and
said electronic control and operation system having a programmable logistics controller being electrically connected with said coin drop system, said digital video and audio memory media and said video monitor and said audio system and being substantially continuously operative for selection of a standby mode during which a first loop video/audio presentation of said digital video and audio memory media is substantially continuously presented and upon sensing a signal from said coin drop system, selecting an article purchase mode during which a second video/audio presentation of said digital video and audio memory media is presented, said programmable logistics controller of said electronic control and operation system returning said electronic control and operation system to said standby mode upon completion of the video/audio presentation of said article purchase mode.

8. The coin actuated, computer controlled bulk article dispensing machine of claim 5, comprising:
a circuit board being mounted within said machine housing;
an article hopper being mounted within said machine housing for containing a quantity of articles to be serially dispensed, said article hopper having an article discharge outlet;
a power supply being mounted to said circuit board and converting ac electric power to dc electric power having a designated voltage;
a programmable logistics controller being mounted to said circuit board and being powered by said designated designated voltage;
a coin activated switch being mounted to said machine housing and having a coin drop signal conductor connected with said programmable logistics controller;
a hopper motor being mounted to said article hopper and controlling discharge of articles from said article discharge outlet, said hopper motor being electrically connected for operation by said programmable logistics controller responsive to an electronic coin drop signal; and
a compact flash card interface and an audio amplifier being mounted to said circuit board and having controlled connection with said programmable logistics controller.

9. The coin actuated, computer controlled bulk article dispensing machine of claim 5, comprising:
said computer controlled system having a standby mode presenting a first substantially continuous loop video and audio presentation and having an article dispensing mode presenting a second substantially continuous loop video and audio presentation during a selected period of time;
said computer controlled system normally operating said bulk article dispensing machine in said standby mode;
responsive to said coin drop article dispensing signal said computer controlled system terminating said standby mode and activating said article dispensing mode during said selected period of time; and
upon termination of said selected period of time said computer controlled system returning said bulk article dispensing machine to said standby mode.

10. The coin actuated, computer controlled bulk article dispensing machine of claim 5, said computer controlled system comprising:
an electronic control and operation system being mounted within said machine housing and having programmable and replaceable digital video and audio memory media; and
a programmable logistics controller being electrically connected with said coin drop system, said digital video and audio memory media and said video monitor and said audio system and having a standby mode during which a first loop video/audio presentation of said digital video and audio memory media is substantially continuously presented and having an article purchase mode during which a second video/audio presentation of said digital video and audio memory media is presented, said programmable logistics controller normally operating in said standby mode and selecting said article purchase mode responsive to an electronic coin drop signal and returning to said standby mode upon completion of the video/audio presentation of said article purchase mode.

11. A coin actuated, computer controlled bulk article dispensing machine, comprising:
a machine housing having an article storage hopper for articles in position to be seen by customers;
an electrically energized hopper discharge motor being mounted in article dispensing relation with said article dispensing opening;
a coin drop mechanism having a coin drop slot and a having a coin actuated electronic switch;
a programmable logistics controller being electrically connected with said hopper discharge motor and with said coin actuated electronic switch, upon receiving a coin drop signal from said coin actuated electronic switch said programmable logistics controller energizing said hopper discharge motor and dispensing one or more articles;
a computer controlled video monitor being mounted to said machine housing in position for viewing by prospective customers;
an audio system being located within said machine housing;
a recording media player being mounted within said machine housing and having a recording media programmed with video and audio; and
said programmable logistics controller having control connection with said recording media player.

12. The coin actuated, computer controlled bulk article dispensing machine of claim 11, comprising:
said recording media being removably mounted in electronic communication with said recording media player, permitting selective change of recorded video and audio presentations by said computer controlled bulk article dispensing machine.

13. The coin actuated, computer controlled bulk article dispensing machine of claim 11, comprising:
a programmable electronic storage media being electronically connected with said video monitor and audio system; and
a programmable logistics controller being connected to receive said article dispensing signal and being connected for program sequence control of said programmable electronic storage media during a standby mode and during an article dispensing mode.

14. The coin actuated, computer controlled bulk article dispensing machine of claim 11, comprising:
an electronic control and operation system being mounted within said machine housing and having digital video and audio memory media; and
said electronic control and operation system having a programmable logistics controller being electrically connected with said coin drop system, said digital video and audio memory media and said video monitor and said audio system and being substantially continuously operative for selection of a standby mode during which a first loop video/audio presentation of said digital video and audio memory media is substantially continuously presented and upon sensing a signal from said coin drop system, selecting an article purchase mode during which a second video/audio presentation of said digital video and audio memory media is presented, said programmable logistics controller of said electronic control and operation system returning said electronic control and operation system to said standby mode upon completion of the video/audio presentation of said article purchase mode.

15. The coin actuated, computer controlled bulk article dispensing machine of claim 11, comprising:
a circuit board being mounted within said machine housing;
an article hopper being mounted within said machine housing for containing a quantity of articles to be serially dispensed, said article hopper having an article discharge outlet;
a power supply being mounted to said circuit board and converting ac electric power to dc electric power having a designated voltage;
a programmable logistics controller being mounted to said circuit board and being powered by said designated designated voltage;
a coin activated switch being mounted to said machine housing and having a coin drop signal conductor connected with said programmable logistics controller;
a hopper motor being mounted to said article hopper and controlling discharge of articles from said article discharge outlet, said hopper motor being electrically connected for operation by said programmable logistics controller responsive to an electronic coin drop signal; and
a compact flash card interface and an audio amplifier being mounted to said circuit board and having electronically controlled connection with said programmable logistics controller.

16. The coin actuated, computer controlled bulk article dispensing machine of claim 11, comprising:
said computer controlled system having a standby mode presenting a first substantially continuous loop video and audio presentation and having an article dispensing mode presenting a second substantially continuous loop video and audio presentation during a selected period of time;
said computer controlled system normally operating said bulk article dispensing machine in said standby mode;
responsive to said coin drop article dispensing signal said computer controlled system terminating said standby mode and activating said article dispensing mode during said selected period of time; and
upon termination of said selected period of time said computer controlled system returning said bulk article dispensing machine to said standby mode.

17. The coin actuated, computer controlled bulk article dispensing machine of claim 11, said computer controlled system comprising:
an electronic control and operation system being mounted within said machine housing and having programmable and replaceable digital video and audio memory media; and
a programmable logistics controller being electrically connected with said coin drop system, said digital video and audio memory media and said video monitor and said audio system and having a standby mode during which a first loop video/audio presentation of said digital video and audio memory media is substantially continuously presented and having an article purchase mode during which a second video/audio presentation of said digital video and audio memory media is presented, said programmable logistics controller normally operating in said standby mode and selecting said article purchase mode responsive to an electronic coin drop signal and returning to said standby mode upon completion of the video/audio presentation of said article purchase mode.
